(19) United States
(12) Patent Application Publication
(10) Pub. No.: US 2004/0190757 A1
(43) Pub. Date: Sep. 30, 2004

(54) Integrated passenger management system

(76) Inventors: Kevin SJ Murphy, Malvern (GB); Andrew P. Wade, Malvern (GB); Michael H. Burns, Farnborough (GB)

Correspondence Address: NIXON & VANDERHYE, PC, 1100 N GLEBE ROAD, 8TH FLOOR, ARLINGTON, VA, 22201-4714, US

(21) Appl. No.: 10/408,219

(22) Filed: Apr. 8, 2003

(30) Foreign Application Priority Data
Mar. 28, 2003 (GB) GB0307171.9

(51) Int. Cl. G06F 7/04

(52) U.S. Cl. 382/115; 340/5.52; 340/5.83

(57) ABSTRACT

An integrated passenger management system includes a check-in facility comprising a biometric sensor, an identification document check facility arranged to connect to an external database of suspect passengers, a security portal comprising at least a further biometric sensor and a millimeter wave camera, and a boarding gate comprising at least a biometric sensor, wherein a passenger is allowed to board a transport medium associated with the boarding gate if the biometric measurements taken by the biometric sensors at each stage are substantially similar, and the other security checks are passed satisfactorily. An embodiment of the invention provides for the issuance of a boarding card only after the passenger has passed through the security portal. Another embodiment provides for details relating to a first biometric measurement to be stored on a security card, that may be compared to further biometric measurements taken at the different stages of boarding.

This invention relates to the management of passengers at a port or similar area. In particular, it relates to the automation of the embarkation procedure, including check-in, security check, customs check, and boarding of passengers onto the transport medium, and likewise the similar procedures upon disembarkation from the transport medium.

The standard procedure a passenger undergoes when travelling from a port such as an airport involves several separate stages. These usually include checking-in with the carrier to obtain boarding passes and deposit any non-carry on baggage; passing through a security check; passing through a customs check (if an international border is being crossed); and finally having the boarding passes checked and boarding the transport medium. Railway ports and shipping ports often have similar procedures, particularly when an international border is to be crossed.

Some airports, or airlines based within the ports adopt procedures to speed up some of these stages. For example, boarding passes may be dispensed from a machine upon presentation of some sort of electronic ticket, which is of particular use for those passengers who only have hand luggage. This avoids the manual check-in procedure which is often subject to lengthy queues. Such a procedure however does allow the boarding pass obtained by a passenger to be passed to a different passenger after check-in has taken place. This is thus a potential security flaw in the procedure.

WO01/37169 describes an integrated access control system, where passengers are identified by means of a biometric sensor at the check-in stage, and again at the boarding stage, to ensure that the passenger who checked in is the same as the one who boards the aircraft.

The usual security procedure adopted at airports and other ports includes passing the passenger through a metal detector under the scrutiny of a security official, who then either searches the passenger more thoroughly using a hand held metal detector or by a ‘pat-down’ search if the metal detector provides an alert. At the same time the baggage of the passenger is passed through an x-ray machine to identify any materials not permitted in hand luggage. There is frequently a hold-up at such areas when the passenger has to divest of common possessions e.g. change, mobile phones etc on first passing through the metal detector and pass these through the x-ray machine. Such delays can cause queues and frustration amongst passengers and lead to the late boarding of the aircraft or other transport medium.

According to the present invention there is provided an integrated passenger management system comprising:

a) an automatic check-in facility coupled to a biometric sensor for recording a biometric characteristic of a passenger and supplying the passenger with boarding information;

b) a security portal incorporating a biometric sensor, and further incorporating a millimeter wave imager;

c) a central computer system coupled to the automatic check-in facility, and the security portal;

wherein the central computer is arranged to verify that the biometric characteristic recorded at the automatic check-in facility is substantially the same as that recorded at the security portal.

A system according to the present invention may reduce the time spent by the passenger in queuing up for each stage of the embarkation process. As an automatic check-in facility is not directly staffed, it is possible for an airline or other travel provider to provide a greater number of such check-in facilities for a given expenditure. Thus, a greater number of people will be able to use the facility at any given time, leading to reduced passenger waiting time. The check-in incorporates a biometric sensor which each passenger is required to use to provide a biometric measurement. This measurement is used later in confirming the identity of each passenger. The check-in facility may allow passengers to choose a preferred seat, but preferably does not issue a boarding pass.

The system preferably incorporates an automated passport or other identification document checking facility, in which the details on the identification document may be electronically read into the central computer system, along with information taken from an associated biometric sensor system. The document details, which include the identity of the passenger, may then be checked against a database of people, the presence of whom should be alerted to the authorities. If a match is found in the database, an alert can be provided to an official.

Such a database may be administered or controlled by a central authority in communication with police and security agencies around the world. The authority can thus build up a database of people for whom manual checking or questioning is deemed necessary. The database may thus reside on a system located externally to the central computer from the invention, but may be in networked communication with it.

A security portal incorporating a biometric sensor and one or more automated security devices can also lead to quicker throughput of passengers. The use of a biometric sensor will remove the need for passengers to display to a security attendant their passport or other form of identification document. Instead, a biometric measurement is taken and passed to the central computer and compared to those taken from the check-in facility to check that the person has checked in and is hence a valid passenger.

The millimeter wave imager within the security portal will reduce the requirement for an attendant to conduct a body search of the passengers as the images produced by the imager provide some visibility of what the passengers are carrying. Images produced by the imager may be processed using known image processing techniques to aid detection of forbidden items such as knives, gas canisters etc and other contraband items.

Use of the millimeter wave imager may improve the throughput of passengers through the security portal. Items carried on a passenger's person may be observed directly , and so the requirement to delay the passenger by requiring him or her to empty their pockets etc. will be reduced. Preferably the imager is arranged to capture a plurality of images of the passenger from different angles or perspectives. Of course, at times a passenger may need to be manually searched if a satisfactory image of the passenger cannot be obtained, but the invention should reduce the need for such manual searching. A millimeter wave imager that may be used with the present invention is described in International patent application WO0014587-A1

The security portal will preferably incorporate a chemical detection system for detecting chemicals on or about the passenger. Such systems are known and may include means to detect drugs, explosives, or other substances. See, for example, the products of Scintrex Trace Corp, Ottawa, Canada, Ion-Track from GE-Interlogix of MA, USA, and Smiths Detection of Warren, N.J., USA for further information relating to chemical detection systems.

The security portal may advantageously incorporate a metal detection system for detecting the presence of metallic objects on or about the passenger. Such systems are known. See, for example, PCT Publication WO 00/00848, and the products of Quantum Magnetics, San Diego, Calif., USA for further information on suitable metal detection systems.

The security portal will preferably incorporate an X-ray imaging system for imaging the contents of the passenger's luggage or other carry-on items. Such systems are known. See, for example, the products of Rapiscan Security Products, Hawthorne, Calif., USA for further information on suitable X-ray imaging systems.

Incorporation of a biometric sensor into a boarding gate connected to the central computer allows rapid throughput through to the aircraft or other transport medium, whilst ensuring that the person boarding is the same person who checked-in and is the same person who underwent a security check. The biometric sensor for this and for the other stages described herein may be arranged to measure characteristics of the passengers' finger prints, palm prints, voice, iris, gait, face, odour or other suitable characteristics. Biometric sensors suitable for use with the current invention are produced by Identix Incorporated, Los Gatos Calif., USA, among others.

The passenger is preferably issued with a boarding pass on exit from the security portal, assuming that the portal has cleared the passenger. The issuance of the boarding pass is preferably done in combination with a further biometric measurement, wherein this measurement is compared to those previously taken before a boarding pass is issued.

According to a further aspect of this invention there is provided an integrated passenger management system comprising:

a) an automatic check-in facility coupled to a biometric sensor for recording a biometric characteristic of a passenger and supplying the passenger with boarding information;

b) a security portal incorporating a biometric sensor, and further incorporating a millimeter wave imager;

wherein the automatic check-in facility and security portal are connected such that biometric characteristics taken of the passenger by the respective biometric sensors may be compared.

The data recorded by the biometric sensors need not be communicated to a central computer. Instead, the biometric sensors could themselves be in direct communication with the other biometric sensors such that a reading taken at one sensor may be compared with a reading taken from another sensor.

According to a further aspect of the invention there is provided an integrated passenger management system comprising of a security portal through which a passenger is arranged to pass, wherein the security portal includes:

a) a millimeter wave imager arranged to produce an image of the passenger as the passenger passes through the portal, and to process the image to indicate the presence of any suspicious objects;

b) an automated identification document checking facility, the facility being arranged to check identification document details against a database having details of those people for whom a manual check is deemed necessary;

c) a biometric sensor arranged to record for identification purposes a biometric characteristic of the passenger;

wherein the security portal is arranged to provide an alert at the request of at least one of the millimeter wave imager and the identification document checking facility.

In this manner the security portal and identification document check facility are integrated into a single facility along with a biometric sensor. The biometric measurement of a passenger taken at the portal may be used at other stages of the embarkation process. Alternatively, or as well, the biometric measurements taken of the passenger may be passed to a destination port where the passenger is to complete his or her journey. In this way the destination port will know where the passenger commenced his or her journey.

According to a further aspect of the invention there is provided an integrated passenger management system comprising:

a) a check-in facility coupled to a first biometric sensor for recording a biometric characteristic of a passenger and supplying the passenger with boarding information;

b) an identification document check facility comprising an electronic identity document reader arranged to communicate with an external database containing details of those people for whom a manual check is deemed necessary;

c) a security portal incorporating a second biometric sensor, and further incorporating a millimeter wave imager;

wherein the system is arranged to present, at the check-in facility, the passenger with a security card containing information relating to a biometric characteristic recorded using the first biometric sensor, and the security portal is arranged to compare the biometric characteristic as detailed on the security card with a biometric characteristic measured using the second biometric sensor.

In this embodiment the invention is not restricted to cases wherein the check-in facility is automatic. The check-in facility may be similar to those currently in use, except for the addition of a biometric sensor and the ability to provide a security card. Information relating to the biometric measurement taken at the first biometric sensor is contained within the security card. This information is preferably stored in the form of a two dimensional bar code, but may take any suitable form, such as being written to a smart card or a card having a magnetic strip.

Once the passenger has checked in, he or she is free to make his/her way to the security portal, where a second biometric measurement is taken The biometric reading recorded at the second biometric sensor is compared against the biometric details stored upon the security card. If the details tally then the system knows that the passenger has checked-in correctly. At this portal the passenger is viewed by a millimeter wave camera as for previous embodiments. Other security checks such as X-ray, metal detection and chemical detection are preferably carried out as described earlier.

The security card on which the biometric information has been stored may also act as a boarding pass. In this case, it will also contain information relating to the personal travel details of the passenger, such as boarding gate and allocated seat number. Alternatively, a separate boarding pass may be issued at the exit from the security portal or thereabouts. The separate boarding pass will preferably contain details relating to the biometric information, as stored upon the security card.

According to a further aspect of the invention there is provided a method of processing passengers in a port for embarkation onto a transport medium comprising the steps of:

a) checking-in a passenger including taking a biometric measurement of the passenger and passing details of the biometric measurement to a central computer;

b) performing a security check upon the passenger by taking a biometric measurement of the passenger, passing details of the biometric measurement to the central computer, and imaging the passenger with a millimeter wave camera;

c) taking a further biometric measurement of the passenger at a boarding gate associated with the transport medium, passing details of the biometric measurement to the central computer and allowing the passenger to board the transport medium if the biometric measurements taken at each stage are substantially similar.

According to a further aspect of the invention there is provided a method of processing one or more passengers in a port comprising the steps of

a) checking-in a passenger, including taking a first biometric measurement from the passenger, and storing details relating to the biometric measurement to a security card to be held by the passenger;

b) performing a first security check on the passenger by reading an identity document associated with the passenger using an electronic identity document reader;

c) passing details relating to the identity of the passenger to an external database containing details of those people for whom a manual check is deemed necessary;

d) performing a second security check on the passenger at a security portal by taking a second biometric measurement of the passenger, electronically reading the biometric details stored on the security card, and comparing the second biometric measurement with the biometric details stored on the security card;

e) performing a third security check on the passenger at the security portal by imaging the passenger with a millimeter wave camera;

f) issuing a boarding card to the passenger if the first, second and third security checks are passed.

Note that although the current invention is particularly suited to use within airports, it may equally well be employed in shipping ports, and ports within train stations.

The invention will now be described in more detail, by way of example only, with regard to the following Figures, of which:

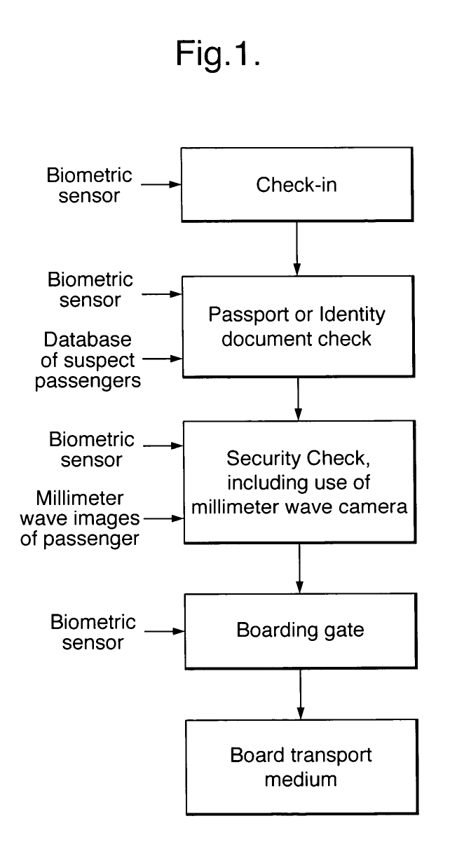

FIG. 1 shows a block diagram of the operation of one embodiment of the current invention;

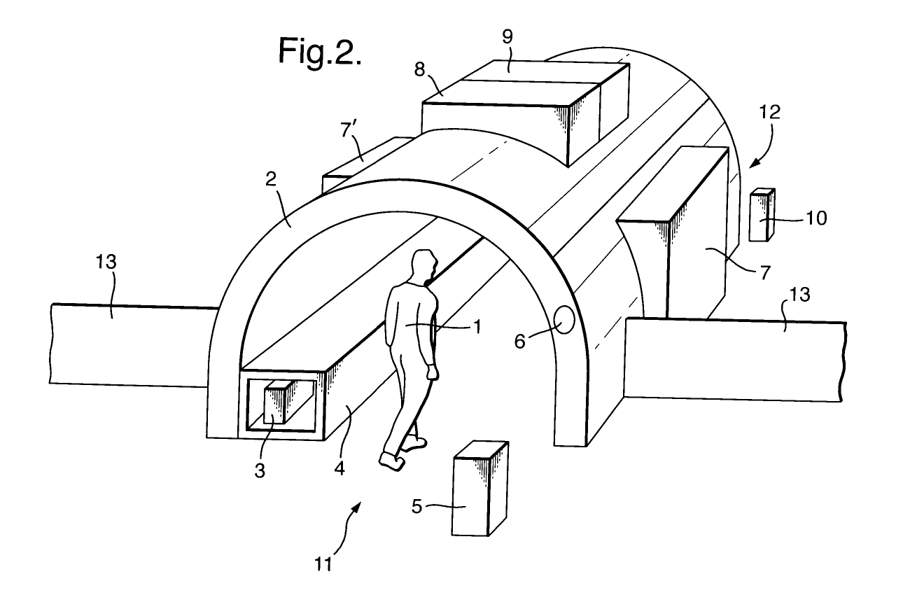

FIG. 2 diagrammatically illustrates a security portal suitable for use with the current invention.

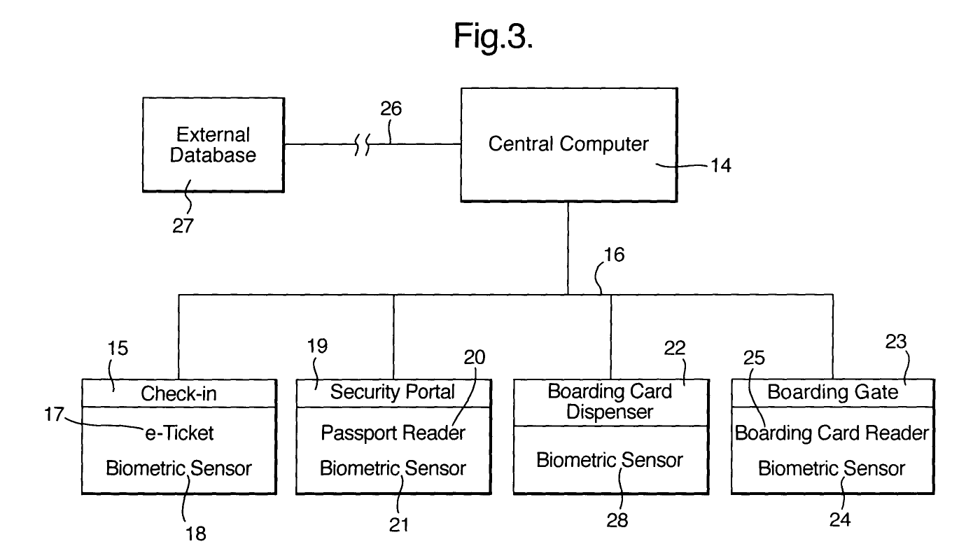

FIG. 3 shows a block diagram indicating the connectivity between the elements of an embodiment of the invention;

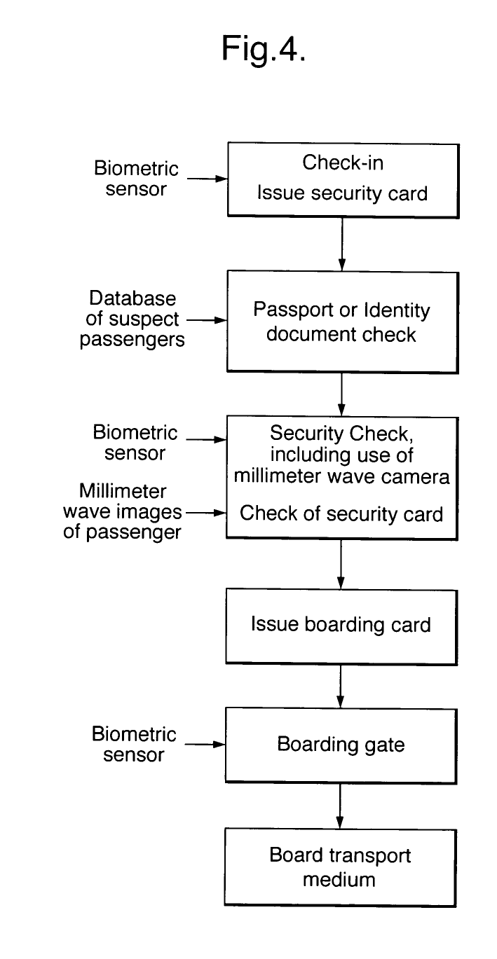

FIG. 4 shows a block diagram of the operation of a further embodiment of the current invention.

FIG. 1 shows the stages involved in processing a passenger through a port from the check-in stage to the boarding stage, according to a first embodiment of the current invention. The description below relates the use of the system in an airport, although, as is stated above, the system may be equally well employed in other ports. Upon arrival at the airport a passenger will check-in using an automated check-in facility. This comprises a touch screen display for inputting and displaying information, a print unit for printing boarding information for the passenger's convenience, a biometric sensor device and, optionally, a facility for collection of any luggage to be placed in the hold of an aircraft upon which he intends to fly. The passenger will be equipped with an electronic ticket reference number which he or she will enter into the check-in facility. He will then place his hand against the biometric sensor which will measure unique characteristics of the hand, so identifying him for future reference. The information from the sensor is passed to a central computer where it is stored. The passenger may, at this point, input desired seating arrangements such as window or aisle seat etc. Any luggage that is to be placed in the hold is then put on the conveyor for despatch to the relevant aircraft via a known security screening process.

Following check-in, the passenger proceeds to the identification check area and security portal. The passenger enters the back page of his passport into a passport reading machine, which electronically reads the passport details, and checks security features of the passport. Document readers supplied by 3M-AiT Limited, of Ottawa, Ontario, Canada, or those of Imaging Automation Inc., of Bedford, N.H., USA are suitable for this purpose. The passport details are then encrypted and passed to the central computer system. This in turn forwards the encrypted details of the passenger via a computer network system to an external computerised database containing details of wanted or suspect people. This returns either an “all clear” message, or some other message requiring action from security personnel.

As an alternative, the identification document check area may be cosited with the automatic check-in area, such that the two operations are performed in immediate succession. In this case, the biometric measurement taken during the check-in procedure will obviate the need for one to be taken during the identification check procedure

The passenger then enters the security portal, which is preferably located adjacent the identification document check area, wherein the passenger again provides a biometric reading by placing his hand against a sensor associated with a security portal. This reading is passed to the central computer which verifies that the passenger has checked-in.

Alternatively, a biometric reading may be taken immediately before the passenger has his identification document checked, and this reading is used as confirmation of his identity for the purposes of passing through the security portal.

The passenger then proceeds through the security portal where he places any hand luggage onto an x-ray screening machine and then passes through a chemical detector gate. All this time the passenger is being observed by a passive millimeter wave imaging system. If, for some reason, the imager is unable to get a satisfactory image of the passenger then a manual check can be done. However, the instances in which this will be necessary should be reduced as compared to the prior art systems. Some facilities may also request that the passenger passes through a metal detector, which may be co-located with the chemical detector gate.

During the traversal of the passenger through the security portal the passenger is monitored by a CCTV camera to ensure proper use of the portal.

Assuming the security and identification check stages are cleared successfully, the passenger then exits the portal and proceeds to an airside area of the airport. Only here—after the security checking procedure—is he issued with a boarding pass. This may be an electronic boarding pass that uses the biometric readings previously taken to verify the passenger's identity when actually boarding the aircraft, or may be a physical boarding pass containing details of the biometric measurements taken previously, or may even be a prior art boarding pass such as is in common use. When the call for boarding of the aircraft is made the passenger then goes to the appropriate gate and presents his hand to another biometric sensor linked to the central computer. The measured biometric characteristic is then checked against that of the one taken at the automatic check-in, and also the one taken at the security portal or, if appropriate, the biometric details contained on the boarding pass. If a match is found then the passenger is positively identified as having been correctly checked-in and as having passed through a security and identification check. The passenger may then board the aircraft.

FIG. 2 shows a representation of the security portal, passport reader and boarding pass dispenser facility. A passenger 1 is shown proceeding through the portal 2. Just prior to this the passenger has placed his passport onto a passport reading machine 5 where the details on the passport have been read in to the computer which can then check the identity of the passenger with the database of suspect travellers. The passenger then put his palm against the biometric sensor 6 to confirm his identity before depositing his luggage 3 into an X-ray imaging machine 4, where its contents may be examined. Details of the biometric reading are sent to the central computer where they are compared against the readings taken during check-in. Hence, in this way it is known that the person currently in the portal has been correctly checked in.

Other biometric measurements that are particularly favoured at present are fingerprint recognition, and facial recognition, although of course any suitable biometric can be used.

If the identity document held by the passenger also includes a record of any biometric information, then this can also be compared with the data recorded by the biometric sensor if both relate to the same biometric, to provide an additional security check.

As the passenger proceeds down the portal he is observed by a millimeter wave imager 7, 7′, which produces images from multiple angles so as to get an all-round view of the passenger. The images produced by the imager can be processed to enhance the detection of suspect or undesirable articles about the passengers person, and an alert sent to a security official if anything untoward is detected.

The portal 2 further includes a metal detector 8 and a chemical detector 9.

On exit from the portal, if no alerts are received from any of the passport reader 5, millimeter wave imager 7, 7′, metal detector 8, chemical detector 9 and X-ray machine 4 then the passenger 1 is free to again provide a biometric reading to a biometric sensor associated with boarding pass dispensing apparatus 10 and collect a boarding pass therefrom, assuming that an electronic boarding pass system is not in use.

The entry side 11 of the portal 1 is within the land side of the port, whilst the exit side 12 of the portal 2 is the traveller side area, e.g. the air-side within an airport or sea-side for sea ports. The barrier 13 prevents passengers from moving from one side to the other without going through the portal 2.

FIG. 3 shows a block diagram of the system according to an embodiment of the current invention, and how it connects together. A central computer system 14 is connected to the automatic check-in facility 15 via a computer network 16. The check-in facility 15 has an e-ticket machine 17 and a biometric sensor 18 as discussed above, which are able communicate with the central computer 14 via the computer network 16. Also connected to the central computer 14 is the security portal which is able to pass information relating to the passport reader 20 and the biometric sensor 21. The boarding pass dispenser 22 and associated biometric sensor 28 is also connected to the central computer 14 via the computer network 16 , as is the boarding gate 23 itself, in order to pass information relating to its biometric sensor 24 and boarding pass reader 25.

The central computer 14 is connected via a separate computer network 26 to an external database 27 holding details of persons who may require further consideration by the port authorities.

Shown in FIG. 4 is a further embodiment of the current invention. Here, upon checking-in, a passenger presents his or her hand to a biometric sensor, which measures unique details relating to the passenger's hand. The passenger then presents an identity document for checking, wherein it is checked by an automatic identity document reader. This checks any machine-readable features for any discrepancies, and also checks for things such as evidence of tampering with any lamination etc. The identity of the passenger is passed to an external agency who have access to a database containing names of people who may be wanted by the authorities, or who otherwise need to be treated differently. If nothing untoward is found, the passenger is issued with a security card upon which is printed information relating to the biometric measurement, in the form of a two dimensional bar code.

The passenger is then able to proceed towards the security portal, to go “airside”. Here, the passenger enters his security card into a reader at the portal, and provides a second biometric reading by placing his palm against a biometric sensor. The portal checks that the data on the security card corresponds to the reading from the biometric sensor and, if so, allows him access through the portal to the airside. As described above for other embodiments, the portal carries out security checks on the passenger using a millimeter wave camera and chemical detector, with a metal detector also being used in some cases.

On exiting the portal, the passenger is issued with a boarding pass which allows passage onto the transport medium. As an alternative, the security card may be reissued to the passenger as a boarding pass, and this will be annotated to indicate that the security check has been performed.

Following exit from the portal the passenger is then free to await boarding of the transport medium, presenting his boarding pass and performing a final biometric measurement which is again compared to the biometric information printed on the boarding pass, before boarding if the comparison is satisfactory.

Note that, although the description herein is directed primarily towards the embarkation procedure, the system and method of the invention may equally be applied to the disembarkation procedure where appropriate. For example, a security check or identification document check according to aspects of the current invention may be applied both at the embarkation and disembarkation stage of use of a travel medium.

The skilled person will be aware that other embodiments within the scope of the invention may be envisaged, and thus the invention should not be limited to the embodiments as herein described.

1. An integrated passenger management system comprising:
a) an automatic check-in facility coupled to a biometric sensor for recording a biometric characteristic of a passenger and supplying the passenger with boarding information;
b) a security portal incorporating a biometric sensor, and further incorporating a millimeter wave imager;
c) a central computer system coupled to the automatic check-in facility, and the security portal;
wherein the central computer is arranged to verify that the biometric characteristic recorded at the automatic check-in facility is substantially the same as that recorded at the security portal.

2. An integrated passenger management system as claimed in claim 1 wherein the system further includes a boarding gate from which a transport medium may be entered, the boarding gate incorporating a biometric sensor linked to the central computer.

3. An integrated passenger management system as claimed in claim 1 or claim 2 wherein the system is arranged to issue a boarding pass to the passenger after the passenger has entered the security portal.

4. An integrated passenger management system as claimed in claim 1 wherein the system further includes an automatic identification document checking facility connected to the central computer, the facility incorporating a biometric sensor, and being arranged to check identification document details against a database having details of those people for whom a manual check is deemed necessary, and to further check that the biometric characteristic measured at this stage substantially matches that recorded at previous stages.

5. An integrated passenger management system as claimed in claim 4 wherein the database is administered externally to the central computer system

6. An integrated passenger management system as claimed in claim 1 wherein the biometric sensor is arranged to check at least one of a finger print or a palm print of the passenger.

7. An integrated passenger management system as claimed in claim 1 wherein the biometric sensor is arranged to check the iris of the passenger.

8. An integrated passenger management system as claimed in claim 1 wherein the security portal further includes a chemical detector for the detection of chemicals on or about the passenger.

9. An integrated passenger management system as claimed in claim 1 wherein the security portal further includes a metal detector for detection of metals on or about the passenger.

10. An integrated passenger management system as claimed in claim 1 wherein the security portal further includes an x-ray imager.

11. An integrated passenger management system as claimed in claim 1 wherein the security portal is arranged to guide the passenger therethrough such that the millimeter wave imager is able to produce images of the passenger from different perspectives.

12. An integrated passenger management system comprising of a security portal through which a passenger is arranged to pass, wherein the security portal includes:
a) a millimeter wave imager arranged to produce an image of the passenger as the passenger passes through the portal, and to process the image to indicate the presence of any suspicious objects;
b) an automated identification document checking facility, the facility being arranged to check identification document details against a database having details of those people for whom a manual check is deemed necessary;
c) a biometric sensor arranged to record for identification purposes a biometric characteristic of the passenger;
wherein the security portal is arranged to provide an alert at the request of at least one of the millimeter wave imager and the identification document checking facility.

13. An integrated passenger management system as claimed in claim 12 wherein the security portal further includes a chemical detector for the detection of chemicals on or about the passenger.

14. An integrated passenger management system as claimed in claim 12 wherein the security portal further includes a metal detector.

15. An integrated passenger management system as claimed in claim 12 wherein the security portal further includes an x-ray imager.

16. An integrated passenger management system comprising:
a) an automatic check-in facility coupled to a biometric sensor for recording a biometric characteristic of a passenger and supplying the passenger with boarding information;
b) a security portal incorporating a biometric sensor, and further incorporating a millimeter wave imager;
wherein the automatic check-in facility and security portal are connected such that biometric characteristics taken of the passenger by the respective biometric sensors may be compared.

17. An integrated passenger management system as claimed in claim 16 wherein the system further includes an automatic identification document checking facility connected to the central computer arranged to check identification document details against a database having details of those people for whom a manual check is deemed necessary.

18. An integrated passenger management system comprising:
a) a check-in facility coupled to a first biometric sensor for recording a biometric characteristic of a passenger and supplying the passenger with boarding information;
b) an identification document check facility comprising an electronic identity document reader arranged to communicate with an external database containing details of those people for whom a manual check is deemed necessary;
c) a security portal incorporating a second biometric sensor, and further incorporating a millimeter wave imager;
wherein the system is arranged to present, at the check-in facility, the passenger with a security card containing information relating to a biometric characteristic recorded using the first biometric sensor, and the security portal is arranged to compare the biometric characteristic recorded on the security card with a biometric characteristic measured using the second biometric sensor.

19. A system as claimed in claim 18 wherein the security card further acts as a boarding pass.

20. A system as claimed in claim 18 wherein the system is arranged to write the information relating to a biometric characteristic in the form of a two dimensional bar code to the boarding pass.

21. A system as claimed in claim 20 wherein there is further provided a boarding gate from which a transport medium may be entered, the boarding gate incorporating a third biometric sensor and being arranged to compare the biometric measurement from the third biometric sensor with the biometric details contained on the boarding pass.

22. A method of processing passengers in a port for embarkation onto a transport medium comprising the steps of:
a) checking-in a passenger including taking a biometric measurement of the passenger and passing details of the biometric measurement to a central computer;
b) performing a security check upon the passenger by taking a biometric measurement of the passenger, passing details of the biometric measurement to the central computer, and imaging the passenger with a millimeter wave camera;
c) taking a further biometric measurement of the passenger at a boarding gate associated with the transport medium, passing details of the biometric measurement to the central computer and allowing the passenger to board the transport medium if the biometric measurements taken at each stage are substantially similar.

23. A method as claimed in claim 22 wherein a boarding pass is issued to the passenger after the passenger has entered the security portal.

24. A method as claimed in claim 22 wherein an identification document belonging to the passenger is scanned by an automatic document reading facility connected to the central computer, and details from the document are passed to a database having details of those people for whom a manual check is deemed necessary.

25. A method as claimed in claim 24 wherein the database is administered externally to the central computer system

26. A method as claimed in claim 24 wherein the document reading facility incorporates a biometric sensor in communication with the central computer system.

27. A method as claimed in claim 22 or claim 26 wherein the biometric sensor is arranged to check at least one of a finger print or a palm print of the passenger.

28. A method as claimed in claim 22 or claim 26 wherein the biometric sensor is arranged to check the iris of the passenger.

29. A method as claimed in claim 22 wherein the security check further includes the step of passing the passenger through a chemical detection system.

30. A method as claimed in claim 22 wherein the security check further includes the step of passing the passenger through a metal detector.

31. A method as claimed in claim 22 wherein the security check further includes the step of passing the passenger's hand luggage through an x-ray imager.

32. A method as claimed in claim 22 wherein the millimeter wave camera produces images of the passenger from a plurality of perspectives.

33. A method of processing one or more passengers in a port comprising the steps of
a) checking-in a passenger, including taking a first biometric measurement from the passenger, and storing details relating to the biometric measurement to a security card to be held by the passenger;
b) performing a first security check on the passenger by reading an identity document associated with the passenger using an electronic identity document reader;
c) passing details relating to the identity of the passenger to an external database containing details of those people for whom a manual check is deemed necessary;
d) performing a second security check on the passenger at a security portal by taking a second biometric measurement of the passenger, electronically reading the biometric details stored on the security card, and comparing the second biometric measurement with the biometric details stored on the security card;
e) performing a third security check on the passenger at the security portal by imaging the passenger with a millimeter wave camera;
f) issuing a boarding card to the passenger if the first, second and third security checks are passed.

34. A method as claimed in claim 33 wherein the boarding card contains details relating to a biometric measurement performed on the passenger.

35. A method as claimed in claim 34 wherein a third biometric measurement is taken of the passenger at a boarding gate associated with the transport medium, and this measurement compared to biometric details contained on the boarding card, and the passenger then being allowed to board the transport medium if the biometric details on the boarding card match those from the third biometric measurement.
